(19) United States
(12) Patent Application Publication
(10) Pub. No.: US 2003/0084169 A1
(43) Pub. Date: May 1, 2003

(54) System and method for accessing a target computer from a remote location using a remote computer

(76) Inventors: Min Zhu, Los Altos, CA (US); Subrah Iyar, Saratoga, CA (US); Srinath Anantharaman, Fremont, CA (US); Yemeng Feng, Union City, CA (US); Alfred Lian Fui Pong, Millbrae, CA (US)

Correspondence Address: Todd M. Briggs, SKJERVEN MORRILL MacPHERSON LLP, Suite 2800, 3 Embarcadero Center, San Francisco, CA, 94111, US

(21) Appl. No.: 10/001,435

(22) Filed: Oct. 31, 2001

(51) Int. Cl. G06F 15/16; G06F 15/177

(52) U.S. Cl. 709/229; 709/221

(57) ABSTRACT

The present invention provides a system and a method for accessing a target computer from a remote location using a remote computer. To access the target computer, a user first accesses a central computer system using a remote computer. Once it is determined that the user has permission to access the target computer, the user can access the target computer via the central computer system.

### BACKGROUND OF THE INVENTION

1. Field of the Invention

The present invention relates to a system and a method for accessing a target computer from a remote location using remote computer.

2. Related Art

Remote access systems allow users to access a computer or a computer network from a remote location using a remote computer. For example, employees of businesses can use remote access systems to gain access to their business computers or their business computer network from various remote locations such as their homes, a branch office, or while traveling.

There are several remote access systems that are commercially available today such as pcAnywhere produced by Symantec Corporation of Cupertino, Calif., Carbon Copy produced by Compaq Corporation of Houston, Tex., and Timbuktu produced by Netopia Incorporated of Alameda, Calif. These remote access systems include software that must be installed on a target computer, such as a user's office computer or office computer system, and software that must be installed and on a remote computer, such as a user's home computer.

One disadvantage of the conventional remote access systems described above is that it is difficult and cumbersome to install and configure the software on the remote computers. The user must install software on the remote computer and then perform a configuration process, which typically requires entering information such as the target computer's Internet Protocol (IP) address and a telephone number associated with the target computer's modem. Many users have difficulty performing these configuration steps and in some cases fail to perform these configuration steps successfully. As a result, the user will not be able to access the target computer. Even if the user is able to perform these configuration steps, it may take an unacceptable amount of time to complete these steps. Another disadvantage of conventional remote access systems is that they do not support dynamic IP addressing systems that are widely used in various network environments. Yet another disadvantage of conventional remote access systems is that it is often difficult or impossible to access computers that are located behind firewalls using such conventional remote access systems. Yet another disadvantage of conventional remote access systems is that they do not allow applications to be remotely accessed during data conferences.

Accordingly, what is needed is an improved system and method for accessing a target computer using a remote computer.

### SUMMARY OF THE INVENTION

The present invention provides a system and a method for accessing a target computer from a remote location using a remote computer. To access the target computer, a user first accesses a central computer system using a remote computer. Once it is determined that the user has permission to access the target computer, the user can access the target computer via the central computer system. In some embodiments, the user may be required to perform a phone authentication procedure before the user can access the target computer. In some embodiments, the user can access the target computer during a data conference and thus share applications that are located on the target computer with other participants of the data conference.

Other embodiments, aspects, and advantages of the present invention will become apparent from the following descriptions and the accompanying drawings.

### BRIEF DESCRIPTION OF THE DRAWINGS

For a more complete understanding of the present invention and for further embodiments, aspects, and advantages, reference is now made to the following description taken in conjunction with the accompanying drawings, in which:

FIG. 1 is a block diagram of an exemplary remote access system, according to some embodiments of the present invention.

FIG. 2 is a flowchart of an exemplary method for setting up a remote access account, according to some embodiments of the present invention.

FIG. 3 is a flowchart of an exemplary method for setting up a target computer, according to some embodiments of the present invention.

FIG. 4 is a flowchart of an exemplary method of operation during a remote access session, according to some embodiments of the present invention.

### DETAILED DESCRIPTION OF THE INVENTION

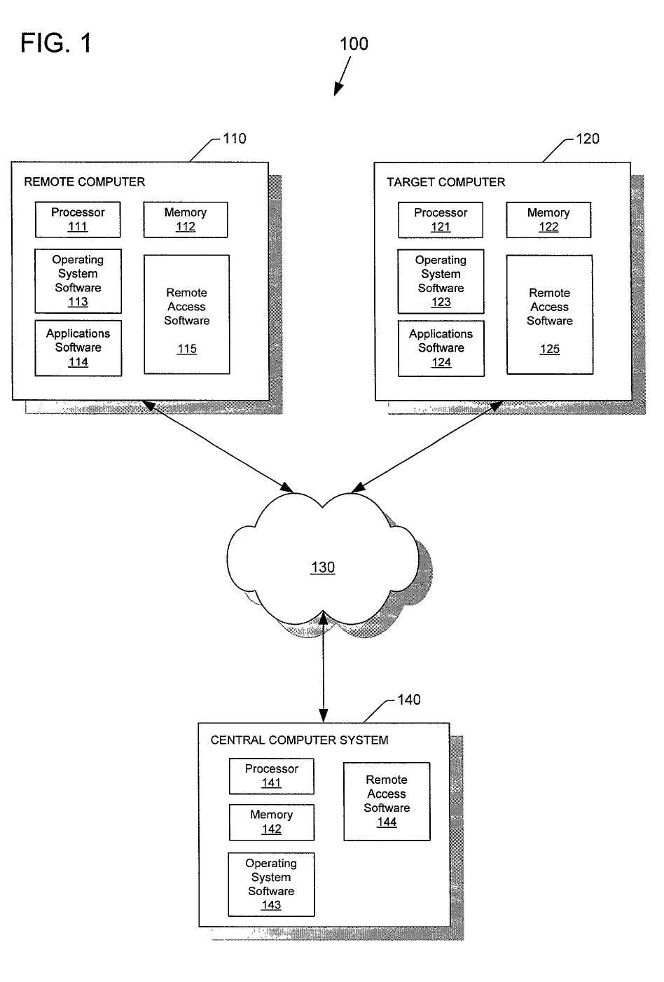

The preferred embodiments of the present invention and their advantages are best understood by referring to FIGS. 1 through 4 of the drawings. Like reference numerals are used for like and corresponding parts of the various drawings. The preferred embodiments are merely illustrative and are not in any way intended to limit the scope of the present invention as defined by the accompanying claims.

System Architecture

FIG. 1 is a block diagram of an exemplary remote access system 100, according to some embodiments of the present invention. A remote computer 110 is connected to a central computer system 140 via a global area computer network 130. The connection between remote computer 110 and central computer system 140 can be any type of connection that allows data to be transferred between remote computer 110 and central computer system 140, such as a HyperText Transport Protocol (HTTP) connection. To ensure that the connection between remote computer 110 and central computer system 140 is secure, the data transferred over the connection can be encrypted using any suitable encryption techniques, such as Secure Sockets Layer (SSL) encryption. A target computer 120 is connected to central computer system 140 via global area computer network 130. The connection between target computer 120 and central computer system 140 can be any type of connection that allows data to be transferred between target computer 120 and central computer system 140, such as a HTTP connection. To ensure that the connection between target computer 120 and central computer system 140 is secure, the data transferred over the connection can be encrypted using any suitable encryption techniques such as SSL encryption.

As described in greater detail below, a user can use remote computer 110 to connect to central computer system 140. Once connected, the user can access target computer 120 as long as target computer 120 has established a connection with central computer system 140. For clarity, remote access computer system 100 is depicted with a single remote computer 110, a single target computer 120, and a single computer at central computer system 140. It should be recognized, however, that remote access system 100 will typically include multiple remote computers 110, multiple target computers 120, and central computer system 140 will include multiple computers (e.g., different types of servers).

Remote computer 110 includes processor 111, memory 112, operating system software 113, applications software 114, and remote access software 115. Processor 111 can be any suitable processor, such as a member of the Pentium family of processors. Memory 112 can be any type of suitable memory, such as DRAM, SRAM, a magnetic hard drive, an optical hard drive, or any combination thereof. Operating system software 113 can be any type of suitable operating system software, such as MS-DOS, WINDOWS 95, 98, NT, ME, 2000, or XP, one of the many versions of UNIX (Solaris, Linux, etc.), or the Macintosh OS. Applications software 114 can be a word processing application, a spreadsheet application, a computer-aided drafting application, or any other type of application. It should also be recognized that remote computer 110 can be any type of electronic device capable of communicating with central computer system 140 and displaying information to a user. For example, remote computer 110 can be a personal digital assistant (PDA), a cellular telephone, or other like devices.

Remote access software 115 includes one or more computer programs. The one or more computer programs include computer instructions that, among other things, enable a user to connect to central computer system 140 and access target computer 120 via central computer system 140. Remote access software 115 can also include other software components such as software that enables a user to share applications, documents, or the like during a data conference. In some embodiments, remote access software 115 is a software plug-in that is downloadable from a service provider's website.

Target computer 120 includes processor 121, memory 122, operating system software 123, applications software 124, and remote access software 125. Processor 121 can be any suitable processor, such as a member of the Pentium family of processors. Memory 122 can be any type of suitable memory, such as DRAM, SRAM, a magnetic hard drive, an optical hard drive, or any combination thereof. Operating system software 123 can be any type of suitable operating system software, such as MS-DOS, WINDOWS 95, 98, NT, ME, 2000, or XP, one of the many versions of UNIX (Solaris, Linux, etc.), or the Macintosh OS. Applications software 124 can be a word processing application, a spreadsheet application, a computer-aided drafting application, or any other type of application.

Remote access software 125 includes one or more computer programs. The one or more computer programs include computer instructions that, among other things, enable a user to connect to central computer system 140 and access target computer 120 via central computer system 140. In some embodiments, remote access software 125 is an executable file that is that is downloadable from a service provider's website.

Remote access software 125, which runs on target computer 120, may be different than and function in a different manner than remote access software 115, which runs on remote computer 110. The functions of both remote access software 115 and remote access software 125 are discussed in greater detail below.

Central computer system 140 includes a computer having a processor 141, memory 142, operating system software 143, and remote access software 144. Processor 141 can be any suitable processor, such as a member of the Pentium family of processors. Memory 142 can be any type of suitable memory, such as DRAM, SRAM, a magnetic hard drive, an optical hard drive, or any combination thereof. Operating system software 143 can be any type of suitable operating system software, such as MS-DOS, WINDOWS 95, 98, NT, ME, 2000, or XP, one of the many versions of UNIX (Solaris, Linux, etc.), or the Macintosh OS. For clarity, central computer system 140 is depicted as a single computer. However, central computer system 140 will generally include multiple computers that perform different functions (e.g., different types of servers). Central computer system 140 can include a web server that provides a website that can be accessed by remote computer 110 and target computer 120 via the Internet.

Remote access software 144 includes one or more computer programs. The one or more computer programs include computer instructions that, among other things, enable a user to connect to central computer system 140 and access target computer 120 via central computer system 140.

Remote access software 144, which runs on central computer system 140, is different than and functions in a different manner than remote access software 115, which runs on remote computer 110, and remote access software 125, which runs on target computer 120.

Global area computer network 130 can be any type of computer network that includes numerous computers connected to one another by communications links. In some embodiments, global area network 130 is the Internet.

Remote Access Account Setup

Before a user can set up a target computer 120 for remote access, the user establishes a user account with a service provider. The service provider can operate a central computer system 140, which includes a website. The service provider can provide the remote access service of the present invention and may provide additional services such as data conferencing services. An example of a service provider is WebEx Communications, Inc. of San Jose, Calif.

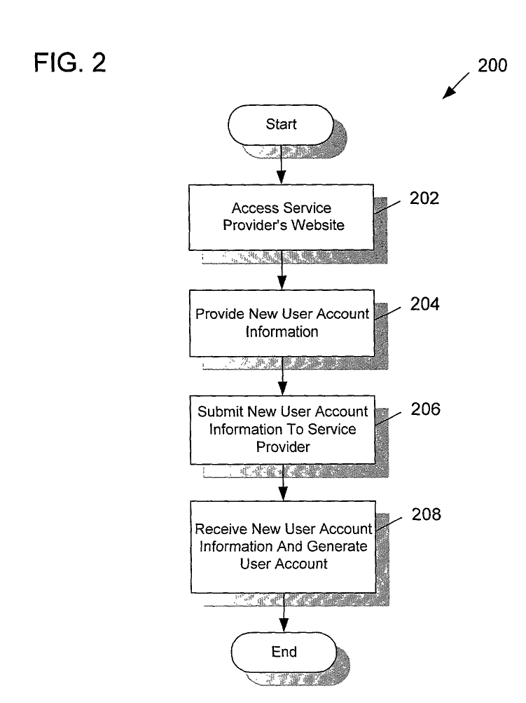

FIG. 2 is a flowchart of an exemplary method 200 for setting up a remote access account, according to some embodiments of the present invention. In step 202, the user accesses the service provider's website. The user can access the service provider's website by typing in the service provider's URL in the user's web browser.

In step 204, the user provides new user account information. The user can enter new user account information on a webpage provided by the service provider. The new user account information can include authentication information, such as a username and a password, and other account information, such as a credit card number, an email address, a home address, a business address, and the like.

In step 206, the user submits the new user account information to the service provider. The user can submit the new user account information by clicking on an appropriate button on the new user account webpage. The new user account information will then be transmitted to the service provider.

In step 208, the service provider receives the new user account information and generates a user account. In particular, the service provider's computer system (e.g., central computer system 140) receives the new user account information and uses the new user account information to generate the new user account. The new user account can be stored in a database (not shown) that is part of central computer system 140.

Once the user's account has been generated, the user will be able to visit the service provider's website and log into the user's account by providing the user's authentication information (e.g., the user's user name and password) on a login webpage. When the user has logged into his/her account, the user may be provided with a custom homepage that allows the user to use the services provided by the service provider. For example, the user's homepage may include the remote access service of the present invention and a data conferencing service.

Setting Up A Target Computer

Before a user can access a target computer 120 from a remote computer 110, target computer 120 must be set up for remote access. The user or another person with permission to use a target computer 120, such as a member of the management information systems (MIS) department in the user's company, can set up the target computer 120 for remote access.

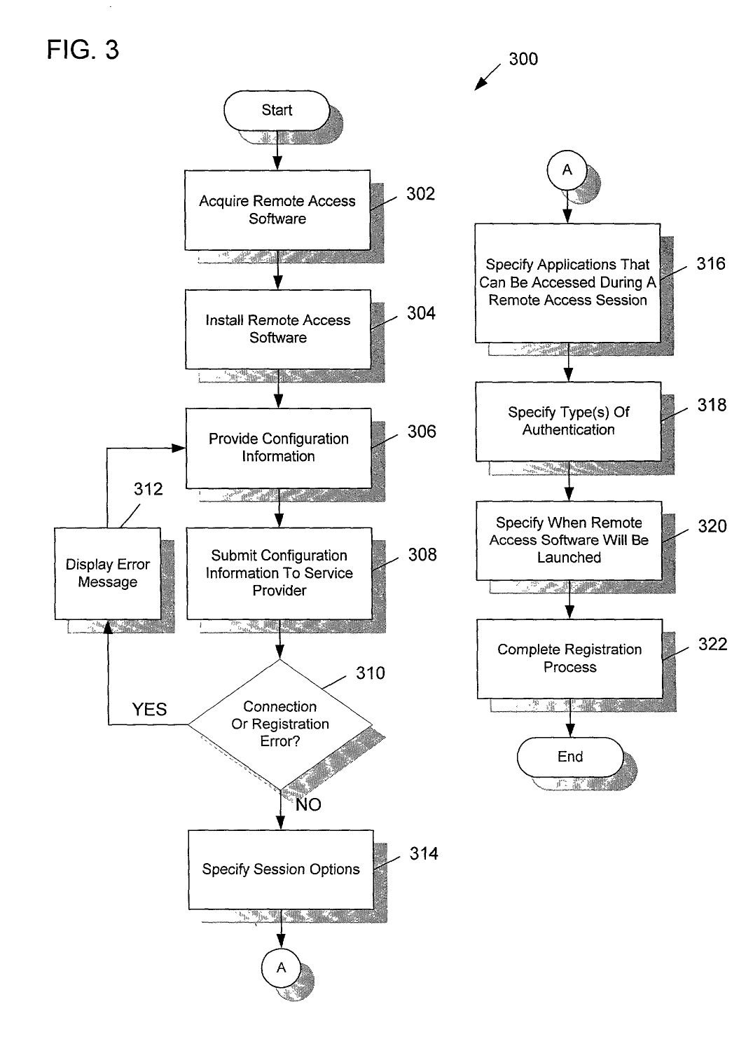

FIG. 3 is a flowchart of an exemplary method 300 for setting up a target computer, according to some embodiments of the present invention. In step 304, the user acquires remote access software 125. To accomplish this, the user can log into the user's account. As explained above, the user may be provided with a homepage. On the homepage, the user can press a button or link that causes remote access software 125 to be downloaded from central computer system 140 onto target computer 120. Remote access software 125 is a computer program that is designed for operation on target computer 120. Remote access software 125 allows target computer 120 to communicate with central computer system 140 and allows a user to access target computer 120 using remote computer 110. Remote access software 125 will generally be provided to the user as an executable file that will then have to be installed on target computer 120.

After remote access software 125 has been downloaded, central computer system 140 generates and sends to the user an email that includes the URL of a computer located at central computer system 140 and a target computer username and password. The URL and the target computer username and password allow target computer 120 to establish a connection with a computer at central computer system 140. Note that the target computer username and password can also be used to link the user's account (and other user's accounts) with target computer 120. As a result, when target computer 120 establishes a connection with central computer system 140, central computer system 140 will be able to determine which user accounts have permission to access target computer 120.

In step 304, the user installs remote access software 125 on target computer 120. The installation process may start automatically or the user may have to manually start the installation process by running the executable file. Remote access software 125 can be installed on target computer 125 by the user or any other person that has access privileges to target computer 125, such as a member of the MIS department in the user's company.

In step 306, the user provides the target computer account information. During the installation process, the user will be presented with one or more windows that require the user to input the target computer account information. The target computer account information can include the following: (1) a URL of a computer at central computer system 140; (2) authentication information (e.g., a target computer username and password); and (3) a nickname for the target computer. The URL of the service provider and the authentication information (e.g., the target computer username and password) is provided so that target computer 120 can log into and establish a connection with central computer system 140. The target computer's nickname must be a unique name that has not been assigned to any other target computers associated with the user's account.

In step 308, the user submits the target computer account information to the service provider. The user can, for example, click on a button that causes target computer 120 to attempt to connect to central computer system 140 using the URL that has been provided by the user. If target computer 120 cannot connect to or register with central computer system 140 (e.g., the URL is invalid, the target computer username and/or password is invalid, or the nickname given to the target computer is already in use) as shown by step 310, method 300 proceeds to step 312 where an error message is displayed to the user. The user will then be given an opportunity to reenter the initial target computer account information (step 306) and connect to central computer system 140 (step 308). If the user successfully connects to and registers with central computer system 140, method 300 proceeds to step 314.

In step 314, the user specifies session options. The session options are default settings that will be used during a remote access session. The session options may include a wide variety of settings such as the following: (1) Automatically reduce screen resolution to match target computer—If this option is selected, the resolution of the remote computer's screen will be automatically reduced to match the resolution of the target computer's screen; (2) Use full-screen view—If this option is selected, the remote computer runs the remote access session in full screen mode by default during a remote access session; (3) Disable the target computer's keyboard and mouse—If this option is selected, the target computer's keyboard and mouse will be disabled during a remote access session; (4) Make the target computer's screen blank—If this option is selected, the target computer's screen is blanked during a remote access session thereby preventing others from viewing the screen activities on the target computer during remote access session; (5) End the session after it is inactive for “X” minutes—If this option is selected, the remote access session will be disconnected if there is no activity for the duration of the specified time X. Numerous other settings will be apparent to those skilled in the art and thus are within the scope of the present invention.

In step 316, the user selects the application(s) that can be accessed during a remote access session. The user can allow the entire desktop (i.e., unfettered access to all of the applications on a target computer 120) to be accessed via a remote computer 110 during a remote access session, or the user can allow certain applications to be accessed via a remote computer 110 (e.g., only Microsoft Word and Intuit Quickbooks) during a remote access session. The ability to access pre-selected applications instead of all applications that are available from the target computer is one unique feature of the present invention.

In step 318, the user selects the type(s) of authentication that will be required to access a target computer 120. Several types of authentication may be required by the user. At least one level of authentication will generally be required. The most basic type of authentication may, for example, be a username and a password. Other types of authentication may also be used with the present invention, such as a biometric form of authentication (i.e., identification based on any type of unique biological characteristics such as voice, retinal, or fingerprint identifications) and phone authentication (described below).

In some embodiments, the user can require phone authentication. If the user requires phone authentication, the user can provide a telephone number and a numeric identification code. The telephone number and the numeric identification code are stored on target computer 120. When the user attempts to access target computer 120 using a remote computer 110, central computer system 140 will query target computer 120 for the telephone number. Central computer system 140 will then receive the telephone number from target computer 120 and call the telephone number. The user will answer the telephone call and enter the numeric identification code when prompted by an automated voice. The numeric identification code is then sent to target computer 120 where target computer 120 determines whether the numeric identification code entered by the user matches the numeric identification code provided by the user when target computer 120 was set up. If the numeric identification code entered by the user matches the numeric identification code provided by the user, target computer 120 will notify central computer system 140 that the user can access target computer 120 from remote computer 110. By storing the telephone number and the numeric identification code on target computer 120, rather than at central computer system 140, a higher level of privacy and security is maintained as this information is made available only to the user and not available to anyone else, including operators of the central computer system 140.

In step 320, the user specifies whether remote access software 125 will be launched each time target computer 120 is started or rebooted. If remote access software 125 has been launched (i.e., remote access software 125 is running), target computer 120 uses the URL and the target computer username and password to establish a connection or log into central computer system 140. Once a connection has been established, the user will be able to access target computer 120 from remote computer 110. On the other hand, if remote access software 125 has not been launched (i.e., remote access software 125 is not running), target computer 120 will not have a connection established or be logged into central computer system 140 and thus a user will not be able to access target computer 120 from remote computer 110. The target computer account information (e.g., the URL, the target computer username, and the target computer password) is stored on target computer 120 so that remote access software 125 can automatically reconnect to central computer system 140 each time target computer 120 is started. Likewise, if target computer 120 is rebooted, target computer 120 can reconnect to central computer system 140 using the configuration information (i.e., the URL, the username, and the password) stored on target computer 120. Note that even when target computer 120 has a dynamic IP address, target computer 120 can establish a connection easily with central computer system 140 since the connection is initiated by target computer 120 and not central computer system 140.

It is important to note that in most corporate network environments, central computer 140 will not be allowed to maintain a persistent connection with target computer 120 for security reasons (i.e., if the central computer could initiate and maintain a connection with target computer 120, then any computer could potentially establish a connection with target computer 120 thereby jeopardizing the security of target computer 120). The present invention circumvents this problem since target computer 120 initiates and establishes the connection with central computer system 140.

In step 322, the user completes the registration process. The user can complete the registration process by clicking on a finish button. This may cause some or all of the information that has been provided by the user in method 300 (i.e., steps 306, 308, 314, 316, 318, and 320) to be sent to central computer system 140 where the information can be stored. This may also cause some or all of the information that has been provided by the user in method 300 to be stored locally at target computer 120.

Note that a user can change the session options, authentication options, and applications that can be accessed after target computer 120 has been setup (i.e., after method 300 has been performed). The user can accomplish this by launching remote access software 125 on target computer 120 and then changing the options in a manner similar to that described above in connection with method 300. The user may also be able to accomplish this by logging into the user's account via a remote computer 120 and changing the options.

The user may also be able to access a log folder to view the access history of the target computer. The access history may include detailed access information such as the date and time the target computer was accessed, which applications were accessed, how long the target computer was accessed, how long each application was accessed, and other like access information.

If new versions of the remote access software 125 become available, central computer system 140 can automatically provide the newer versions to target computer 120 or allow the operator of target computer 120 to download and install the newer version.

A site administrator may also be given superior control over target computer 120. For example, the site administrator (e.g., a member of the MIS department in a company) may be able to perform functions such as approving the user, reviewing the configuration information, killing a session, or blocking a target computer.

Although method 300, has described how a target computer can be set up so that a single user can access the target computer, it should be recognized that method 300 can be modified so that multiple users can access the target computer. Furthermore, it should be recognized that each user may have different access privileges on target computer. For example, a first user may have access to all applications on the target computer while a second user can only access a single application on the target computer.

Remote Access Session

Once target computer 120 has been setup, a user can start a remote access session. During a remote access session, a user can access target computer 120 from a remote computer 110. Remote computer 110 can be located anywhere in the world. The only requirement is that remote computer 110 must be capable of establishing a connection with central computer system 140. Thus, if central computer system 140 provides a website, remote computer 110 can access central computer system 140 as long as remote computer 110 has a web browser and access to the Internet.

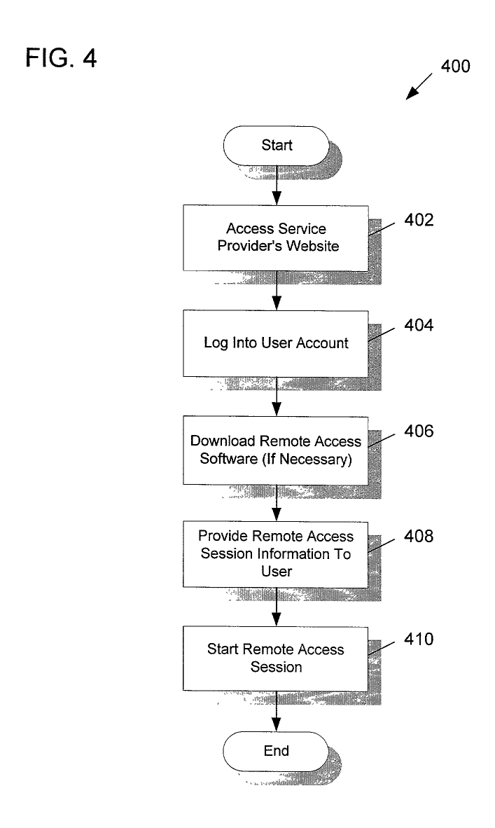

FIG. 4 is a flowchart of an exemplary method of operation 400 during a remote access session, according to some embodiments of the present invention. In step 402, the user accesses the service provider's website. The user can access the service provider's website by typing in the service provider's URL in the user's web browser.

In step 404, the user logs into the user's account. The user will have to provide user account authentication information, such as a username and password, to log into the user's account. When the user logs into the user's account, the website can provide the user with a custom user homepage that includes a list of each target computer 120 that has been setup under the user's account (as described above).

In step 406, the user downloads remote access software 115. Remote access software 115 is designed for operation on remote computer 110. In some embodiments, remote access software 115 is a plug-in that is downloaded from the service provider's website. The user can click a button or link on one of the webpages provided at the service provider's website to download the plug-in. This will cause remote access software 115 to be downloaded to remote computer 110. Once downloaded, remote access software 115 will be operational on remote computer 110. The user will not have to perform any installation or configuration procedures. This is advantageous since it allows remote computer 110 to be operational with the click of a single button or link. Note that step 406 will not be necessary if the user has previously used remote computer 110 during a remote access session since remote access software 115 will already be installed on remote computer 110.

In step 408, remote access session information is provided to the user. The remote access session information can be provided to the user via a webpage once the user has successfully logged into his/her account. The webpage may show the following information associated with each target computer 120: (1) Name—This field shows the nickname of each target computer the user can access; (2) Status—This field shows the status each target computer. Each target computer can have one of the following four statuses: (a) Available—The target computer is online and not in session, i.e., the target computer is available for a remote access session; (b) In Session—The target computer is currently being remotely accessed by a remote computer; (c) Offline—The target computer is not logged in to the central computer system; or (d) Blocked—The target computer is blocked and cannot be accessed by a remote computer; (3) Applications—This field shows the applications that the user can access on each target computer. If a target computer was configured to allow the entire desktop to be accessed (and hence all the applications on the target computer), only the desktop will be listed. In an alternate embodiment, if all applications are to be remotely accessed, all of the applications may be listed. If a target computer is configured to only allow certain applications to be remotely accessed, the selected applications will be listed; (4) Remote Access—This field allows the user to click on a link that will start a remote access session. The following links may be provided in this field: (a) Connect To Desktop—A link that initiates a connection to the target computer and starts a “General Remote Access” session; (b) Connect To An Application—A link that initiates a connection to the target computer and starts a “Selected Remote Access” session with a selected application (e.g., if Microsoft Word is the selected application, the user will be able to access Microsoft Word on the target computer); (c) Disconnect—This link disconnects the target computer and ends the current remote access session.

In step 410, the user starts a remote access session with target computer 120. The user can accomplish this, for example, by clicking on a button or link such as the “Connect to Desktop” or “Connect to an Application” links discussed above. This will cause a connection to be established between remote computer 110 and target computer 120 via central computer system 140.

If phone authentication is required for accessing target computer 120, central computer system 140 can acquire the phone authentication information from target computer 120, call the designated phone number, and instruct the user to enter the numeric identification code. If the phone authentication fails (e.g., the user does not input the correct numeric identification code, the user does not input a numeric identification code, etc.), an error message may be displayed. If the user inputs the correct numeric identification code, a message may be displayed that indicates that a remote access session has been successfully started.

If a “General Remote Access” session has been started, a remote access window or full screen display may open and show the target computer's entire screen or desktop. The user will then have full control of target computer 120.

During a “General Remote Access” session, a remote access menu may also be provided on the remote computer's display which can include the following options: (1) Full-Screen View/Window View—This command allows the user to toggle between full-screen view and window view. Full-screen view displays the session on the entire screen of the remote computer. Window view displays the session in a window on the screen of the remote computer; (2) Transfer File—This command allows the user to transfer files from the target computer to the remote computer (discussed below); (3) Make Target Computer's Screen Blank—This command allows the user to make the target computer's screen blank during the session; (4) Disable Target Computer's Keyboard and Mouse—This command allows the user to disable the target computer's keyboard and mouse during the remote access session; (5) Send Ctrl+Alt+Del Command To Target Computer—This command allows the user to send a Ctrl+Alt+Del command to the target computer. This command is, for example, useful for unlocking a Windows NT machine; (6) Match Screen Resolution—This command allows the user to reduce the screen resolution of the remote computer to match the screen resolution of the target computer; and (7) End Remote Access Session—This command allows the user to end the remote access session.

If a “Selected Remote Access” session has been started, a remote access window may open and show the selected applications. The user will then be able to control the selected application on target computer 120. Note that the user will not have access to all of the applications on target computer 120.

During a “Selected Remote Access” session, a remote access menu may also be provided which can include numerous options including: (1) Full-Screen View/Window View—This command allows the user to toggle between full-screen view and window view. Full-screen view displays the session on the entire screen of the remote computer. Window view displays the session in a window on the screen of the remote computer; (2) Transfer File—This command allows the user to transfer files from the target computer to the remote computer (discussed below); (3) Access Another Application—This command allows the user to select another application to access (if the user has permission to access other applications on the target computer); This feature is advantageous since conventional remote access systems require the user to switch from one application to another whereas the present invention allows multiple applications to be accessed at the same time; (4) Make Target Computer's Screen Blank—This command allows the user to make the target computer's screen blank during the session; (5) Disable Target Computer's Keyboard and Mouse—This command allows the user to disable the target computer's keyboard and mouse during the session; (6) Send Ctrl+Alt+Del Command To Target Computer—This command allows the user to send a Ctrl+Alt+Del command to the target computer. This command, for example, is useful for unlocking a Windows NT machine; (7) Match Screen Resolution—This command allows the user to reduce the screen resolution of the remote computer to match the screen resolution of the target computer; (8) Bring Shared Application To Front—This command allows the user to move the window displaying the shared application to the front all of the other windows on the remote computer's display; and (9) End Remote Access Session—This command allows the user to end the remote access session.

Application Of The Present Invention: Remote Access Session During Data Conferences

The present invention is particularly useful when used in conjunction with a data conference. A data conference is described in co-pending and commonly-assigned U.S. patent application Ser. No. 09/751,806 entitled “Distributed Application Sharing,” filed Dec. 29, 2000, which is herein incorporated by reference in its entirety.

During a data conference, computer users at different locations communicate via a computer network and share applications, files, or any other information that can be viewed, accessed, or used on one of the user's computers. Each user's computer includes a software program that enables the users to share applications. Users that share applications during a data conference are referred to herein as presenters. Users that receive the shared applications during a data conference are referred to herein as viewers.

The present invention allows a presenter to share an application that is located on a target computer 120 during a data conference. To accomplish this, the presenter first joins or starts a data conference via a remote computer 110. The presenter can then access a target computer 120 using the system and methods of the present invention as described above. The presenter will then be able to share the application that is on the target computer 120 with the viewers during the data conference.

To illustrate how the present invention can be used during a data conference, the following example is provided. Suppose a businessman has prepared a PowerPoint presentation on his business computer located in San Francisco, Calif. The businessman has previously set up an account with a service provider that provides remote access services and data conferencing services. An example of such a service provider is WebEx Communications, Inc. of San Jose, Calif. The businessman has also installed remote access software 125 on his business computer and set up his business computer as a target computer 120 with a central computer system 140. Central computer system 140 provides a website.

Next, suppose that the businessman is currently in his hotel room while on a business trip in Paris, France. The businessman has a laptop computer with him, but the laptop computer does not have the aforementioned PowerPoint presentation on it. The hotel room provides Internet access to laptop computers. While in his hotel room, the businessman receives a call from his supervisor who tells him that he needs to give the PowerPoint presentation to customers in New York City in one hour.

Using the present invention, the businessman can give the PowerPoint presentation. First, the businessman uses his laptop to log onto the Internet while in his hotel room. The businessman access the service provider's website and accesses his user account. The businessman then creates a data conference. The businessman starts the data conference and subsequently, the customers in New York City join the data conference. The customers join the data conference by logging onto the Internet via a computer at their office, accessing the service provider's website, and then joining the data conference.

The businessman then uses the service provider's remote access service to connect to his business computer in San Francisco, Calif. Note that the businessman may have to provide identification information and perform one or more authentication steps before he can access his business computer. Once connected, the businessman can access the PowerPoint presentation and give the presentation to the customer in New York City during the data conference.

File Transfer And Printing

The present invention also provides other features such as file transfer and remote printing. A user can transfer files from target computer 120 to remote computer 110 during a remote access session. The user can click on a file transfer button or link which will open a window that shows a map of the folders and the files within each folder on the target computer's hard drive and a map of the folders and the files within each folder on the remote computer's hard drive. The user can then select a file to transfer from target computer 120 to remote computer 110 and select the destination for the file on remote computer 110. Once the file and the destination for the file has been selected, the user can click on a link or button that initiates the file transfer process.

A user can also print files that are located on target computer 120 to a printer that is associated with remote computer 110. During a remote access session, the user will launch an application that resides on target computer 120. When the user attempts to print a file using that application, the file will be converted into a portable document format. A computer program (e.g., a printer driver) that performs this file conversion is included in remote access software 125 that runs on target computer 120. The converted file is then transferred to remote computer 110 and printed out on a local printer that is connected to remote computer 110. Remote access software 125 that runs on remote computer 110 includes a computer program that can read and print documents that are in the portable document format. An advantage of this remote printing feature is that the print driver of the local printer does not have to be installed on the target machine. This allows impromptu printing at any remote location without having apriori knowledge of the printer or the requirement of a driver at the target machine.

Advantages of the Present Invention

The present invention provides at least the following advantages. First, the present invention allows a user to access a target computer without having to be directly connected or logged into the target computer. Rather, the user only needs to be able to access a central computer system via the Internet. Second, the present invention allows a user to access all of the applications that reside on a target computer or only selected applications on the target computer. Third, multiple types of authentication can be used with the present invention to improve security. For example, telephone authentication and biometric forms of authentication can be used with the present invention. Fourth, the present invention allows files to be transferred from a target computer to a remote computer. Fifth, the present invention allows files located on a target computer to be printed locally (i.e., on a printer associated with the remote computer) without preinstalling print drivers on the target computer. Sixth, the present invention provides the capability to access a target computer and share any applications that are available on (or from) the target computer during a data conference. Seventh, the present invention provides end-to-end encryption between a remote computer and a target computer using SSL.

Alternate Embodiments

The order in which the steps of the methods of the present invention are performed is purely illustrative in nature. The steps can be performed in any order or in parallel, unless otherwise indicated by the present disclosure. The methods of the present invention may be performed in hardware, firmware, software, or any combination thereof operating on a computer or computers of any type. Software embodying the present invention may comprise computer instructions in any form (e.g., source code, object code, interpreted code, etc.) stored in any computer-readable medium (e.g., a ROM, a RAM, a magnetic media, a compact disc, a DVD, etc.). Such software may also be in the form of an electrical computer-readable data signal embodied in a carrier wave propagating on a conductive medium or in the form of light pulses that propagate through an optical fiber.

While particular embodiments of the present invention have been shown and described, it will be apparent to those skilled in the art that changes and modifications may be made without departing from this invention in its broader aspect and therefore, the appended claims are to encompass within their scope all such changes and modifications as fall within the true spirit of this invention.

What is claimed is:

1. A method comprising:
receiving a request to access a target computer from a remote computer at a central computer system;
determining whether the remote computer has permission to access the target computer; and
allowing the remote computer to access the target computer if the remote computer has permission to access the target computer.

2. The method of claim 1 further comprising:
allowing the remote computer to access all of the applications that are located on the target computer if the remote computer has permission to access the target computer.

3. The method of claim 1 further comprising:
allowing the remote computer to access only some of the applications that are located on the target computer if the remote computer has permission to access the target computer.

4. The method of claim 1 further comprising:
receiving a request to establish a connection from the target computer at the central computer system.

5. The method of claim 1 further comprising:
accessing a stored telephone number;
dialing the telephone number;
receiving a numeric identification code;
comparing the numeric identification code to a stored numeric identification code; and
allowing the remote computer to access the target computer if the received numeric identification code matches the stored identification code.

6. The method of claim 1 further comprising:
allowing the remote computer to access an application on the target computer while the remote computer is participating in a data conference.

7. The method of claim 1 further comprising:
allowing the remote computer to transfer a file from the target computer to the remote computer.

8. The method of claim 1 further comprising:
allowing the remote computer to print a file that is associated with an application located on the target computer on a local printer without requiring a local printer driver to installed on the target computer.

9. The method of claim 1 wherein the target computer stores a URL that identifies the central computer system and the target computer uses the URL to establish a connection with the central computer system.

10. The method of claim 1 wherein the target computer stores a username and password and the target computer uses the username and password to establish a connection with the central computer system.

11. A computer system including:
one or more computers; and
one or more computer programs, the one or more computer programs comprising computer instructions for:
receiving a request to access a target computer from a remote computer at a central computer system;
determining whether the remote computer has permission to access the target computer; and
allowing the remote computer to access the target computer if the remote computer has permission to access the target computer.

12. The computer system of claim 11 wherein the one or more computer programs farther comprise computer instructions for:
allowing the remote computer to access all of the applications that are located on the target computer if the remote computer has permission to access the target computer.

13. The computer system of claim 11 wherein the one or more computer programs further comprise computer instructions for:
allowing the remote computer to access only some of the applications that are located on the target computer if the remote computer has permission to access the target computer.

14. The computer system of claim 11 wherein the one or more computer programs further comprise computer instructions for:
receiving a request to establish a connection from the target computer at the central computer system.

15. The computer system of claim 11 wherein the one or more computer programs further comprise computer instructions for:
accessing a stored telephone number;
dialing the telephone number;
receiving a numeric identification code;
comparing the numeric identification code to a stored numeric identification code; and
allowing the remote computer to access the target computer if the received numeric identification code matches the stored identification code.

16. The computer system of claim 11 wherein the one or more computer programs further comprise computer instructions for:
allowing the remote computer to access an application on the target computer while the remote computer is participating in a data conference.

17. The computer system of claim 11 wherein the one or more computer programs further comprise computer instructions for:
allowing the remote computer to transfer a file from the target computer to the remote computer.

18. The computer system of claim 11 wherein the one or more computer programs further comprise computer instructions for:
allowing the remote computer to print a file that is associated with an application located on the target computer on a local printer without requiring a local printer driver to be installed on the target computer.

19. The computer system of claim 11 wherein the target computer stores a URL that identifies the central computer system and the target computer uses the URL to establish a connection with the central computer system.

20. The computer system of claim 11 wherein the target computer stores a username and password and the target computer uses the username and password to establish a connection with the central computer system.
